(19) United States
(12) Patent Application Publication
(10) Pub. No.: US 2019/0141562 A1
(43) Pub. Date: May 9, 2019

(54) SYSTEM AND METHOD FOR NETWORK TRAFFIC SLICING

(71) Applicant: CENTRE FOR DEVELOPMENT OF TELEMATICS, New Delhi (IN)

(72) Inventors: Vipin TYAGI, New Delhi (IN); SOUNDARAKUMAR M, Karnataka (IN); Bluemax STEPHEN, Karnataka (IN); Udayasree GORANTLA, Karnataka (IN)

(73) Assignee: CENTRE FOR DEVELOPMENT OF TELEMATICS, New Delhi (IN)

(21) Appl. No.: 16/096,183

(22) PCT Filed: Apr. 26, 2017
(86) PCT No.: PCT/IB17/52404

§ 371 Date: Oct. 24, 2018

(30) Foreign Application Priority Data
Apr. 27, 2016 (IN) 201611014694

(51) Int. Cl. H04W 28/02; H04L 12/24; H04W 8/00; H04W 64/00

(52) U.S. Cl. CPC H04W 28/0215; H04L 41/0893; H04W 28/0226; H04W 8/005; H04W 64/003; H04L 41/0816

(57) ABSTRACT

Aspects of present disclosure relate to a system and method for network traffic slicing for next generation network communications. The network traffic slicing can be enabled to secure a certain amount of capacity of a single network slice, irrespective of the other network slices that co-exist. In an aspect, the proposed system and method for network traffic slicing uses 3GPP (third generation partnership project or any cellular network like 3G, or 2G, or 4G, or 5G) and non-3GPP (comprises of WiMAX or WiFi wireless means) networks depending on the proximity of the two devices, which needs to communicate. Also, the system and method can be configured at a centralized network traffic controller or network device, which can be one or more combinations of a gateway device, routers, switches, servers etc. that can decide mode of communication for enabling communication between IoT devices (for e.g. static or mobile communicable devices) based on different parameters.

### TECHNICAL FIELD

The present disclosure generally relates to the field of communication networks. In particular, the present disclosure pertains to a system and method for network traffic slicing in next generation networks.

### BACKGROUND

Background description includes information that may be useful in understanding the present invention. It is not an admission that any of the information provided herein is prior art or relevant to the presently claimed invention, or that any publication specifically or implicitly referenced is prior art.

The Internet of Things (IoT) has evolved from the convergence of wireless technologies, micro-electromechanical systems (MEMS) and the Internet. The IoT allows people and things to be connected anytime, at any-place, with anything and anyone, ideally using any path/network and any service. A future network of networks could be laid out as public/private infrastructures connecting IoT devices. As more and more IoT devices are getting connected, networks densification is becoming the dominant theme that needs to be addressed for evolution of next generation networks. One of the major concerns for next generation networks (NGN) is the increase in density of devices communicating with each other. The number of connected devices and the device density on the communication network or mobile network is increasing. For example, a typical fully automated home may have N number of devices (such as sensors, actuators etc) that needs to be send/receive data/command to/from the user devices and hence in a general set-up may require N active connections, which leads to higher network density. As different IoT devices may have different capability and may use different communication standard, management for such network is becoming more complex.

Most of the connections/links between the IoT devices may be preconfigured and data between the two devices generally routes through the preconfigured connections/links, irrespective of location of two devices, and irrespective of other alternative mode of communication available between the two devices. Irrespective of the location, if a mobile device has to communicate with another mobile device, even if both the mobile devices are next to each other, the call is routed via the 3GPP network and full procedure for 3GPP routing needs to be followed. Routing the call through the 3GPP network may have cost associated with it, which the user may want to avoid.

None of the existing techniques and methodologies solves the problem when network density and complexity increases within a communication network. As one may appreciate, the increasing network density and complexity impacts the quality of services (QoS) of communication within IoTs and mobile phones or devices belonging to same or different geographical area.

There exist need for systems and methods that can minimize the complexity of the next generation network and reduce the cost of communication, wherever possible. There is therefore a need for a system and method for network traffic slicing that can reduce the traffic density and complexity on the next generation mobile networks.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

### OBJECTS OF THE INVENTION

An object of the present disclosure is to provide a system and method for network traffic slicing for next generation communication networks.

Another object of the present disclosure is to provide a system and method for network traffic slicing that can reduce traffic density and network congestion from next generation communication networks.

An object of the present disclosure is to provide systems and methods that can minimize the complexity of the next generation network and reduce the cost of communication, wherever possible.

### SUMMARY

Aspects of present disclosure relate to a system and method for network traffic slicing for next generation network communications. The network traffic slicing can be enabled to secure a certain amount of capacity of a single network slice, irrespective of the other network slices that co-exist.

Aspect of the present disclosure provides a system for network traffic slicing. The system includes a logical grouping module configured to, dynamically group connected devices into plurality of logical groups based on different attributes, and a communication mode selection module configured to, determine location of two devices that needs to communicate, and association of the two devices with a particular group out of the plurality of logical groups and determine a mode of communication based on any or combination of the location of two device, and the association of the two with the particular group.

In an exemplary implementation, the system can further include a non-3GPP communication module configured to, use non-3GPP mode of communication when the two devices are in close proximity and a 3GPP communication module configured to, use 3GPP mode of communication when the two devices are at wider distance.

In different implementations, the different attributes can be any or a combination of location of device, type of device, available alternatives of communication, and expected data size. Location of the two devices can be determined using any or combination of GPS position discovery, cellular tower based location discovery, and connection of the two with a particular network device.

In an aspect, the proposed system and method for network traffic slicing uses 3GPP (third generation partnership project or any cellular network like 2G or 3G, or 4G or 5G) and non-3GPP (including WiMAX or WiFi wireless means) networks depending on the proximity of the two devices, which needs to communicate. In another aspect, the proposed system and method for network traffic slicing uses network which can be implemented as one of the different types of networks, such as intranet, local area network (LAN), wide area network (WAN), the internet, and the like. The network may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Also, the network can include any new technology that comes in future for communication. Further the network may include a variety of network devices, including routers, bridges, servers, computing devices, storage devices, and the like.

In an aspect, the system and method can configured at a centralized network traffic controller or network device, which can be one or more combinations of a home gateway, a network gateway device, routers, switches, servers etc. that can decide how data packets can be treated and controls the flow or communication between IoT devices (for e.g. static or mobile communicable devices) based on different attributes.

In an exemplary aspect, using the system and method of present disclosure employing traffic slicing, a limited number of connections can be used for connecting maximum number of devices, while minimizing the exposure of communication to outer world and minimizing the cost of communication. In an typical implementation, the present invention enables a home/office, having IoT devices that needs to communicate with each other and with a user device located remotely from the home/office, which could have required several connections, to be managed by a single connection between with the user by a home gateway configured with system and method of present disclosure. The system of present disclosure can decide whether to use the 3GPP or non-3GPP network or any other alternative network to connect the two devices based on the distance of the two devices or based on network on which the device is currently available. The two devices can be any IoT devices which can be static and/or mobile device.

In an exemplary aspect, the present disclosure provides system and method for network traffic slicing based on the determination weather the two device, for example a static devices and/or a mobile devices, are falling within a house, or are connected directly through a single network device, or are falling in the same geographical boundary, and or are belonging to different geographies. The system and method can accordingly assign a 3GPP or non-3GPP network for communication between the two devices (mobile devices and/or the static devices).

In a further exemplary aspect, the system and method for network traffic slicing for next generation networks can allocate network or distribute traffic among different networks, for example 3GPP network or non-3GPP network, is selected based on the network under which two devices are available and if the device is registered at the gateway.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1A illustrates exemplary communication between static devices and a mobile device present within same house in accordance with an embodiment of the present disclosure.

FIG. 1B illustrates exemplary communication between static devices and a mobile device located within same geographical area using a network device in accordance with an embodiment of the present disclosure.

FIG. 1C illustrates exemplary communication between static devices and mobile device belonging to two different geographical region through a network device configured in accordance with an embodiment of the present disclosure.

FIG. 2A illustrates exemplary communication between two mobile devices communicating with each other in accordance with an embodiment of the present disclosure.

FIG. 2B illustrates exemplary communication between two mobile devices located within the same geography in accordance with an embodiment of the present disclosure.

FIG. 2C illustrates exemplary communication between two mobile devices within the same geographical location in accordance with an embodiment of the present disclosure.

FIG. 2D illustrates exemplary communication between two mobile devices belonging to two different geographies in accordance with an embodiment of the present disclosure.

FIG. 3 illustrates functional modules of network traffic slicing system in accordance with an embodiment of the present disclosure.

FIG. 4 illustrates a flow diagram for network traffic slicing method in accordance with an embodiment of the present disclosure.

### DETAILED DESCRIPTION

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, and firmware and/or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

If the specification states a component or feature “may”, “can”, “could”, or “might” be included or have a characteristic, that particular component or feature is not required to be included or have the characteristic.

Although the present disclosure has been described with the system and method for traffic slicing in next generation networks, it should be appreciated that the same has been done merely to illustrate the disclosure in an exemplary manner and any other purpose or function for which the explained structure or configuration can be used, is covered within the scope of the present disclosure.

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product. Various terms as used herein are shown below. To the extent a term used in a claim is not defined below, it should be given the broadest definition persons in the pertinent art have given that term as reflected in printed publications and issued patents at the time of filing.

Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

Aspects of present disclosure relate to a system and method for network traffic slicing for next generation network communications. The network traffic slicing can be enabled to secure a certain amount of capacity of a single network slice, irrespective of the other network slices that co-exist.

Aspect of the present disclosure provides a system for network traffic slicing. The system includes a logical grouping module configured to, dynamically group connected devices into plurality of logical groups based on different attributes, and a communication mode selection module configured to, determine location of two devices that needs to communicate, and association of the two devices with a particular group out of the plurality of logical groups and determine a mode of communication based on any or combination of the location of two device, and the association of the two with the particular group.

In an exemplary implementation, the system can further include a non-3GPP communication module configured to, use non-3GPP mode of communication when the two devices are in close proximity and a 3GPP communication module configured to, use 3GPP mode of communication when the two devices are at wider distance.

In different implementations, the different attributes can be any or a combination of location of device, type of device, available alternatives of communication, and expected data size. Location of the two devices can be determined using any or combination of GPS position discovery, cellular tower based location discovery, and connection of the two with a particular network device. However, it is to be appreciated that the two devices should be registered with network devices to allow direct communication.

In an aspect, the proposed system and method for network traffic slicing uses 3GPP (third generation partnership project or any cellular network like 2G, 3G, 4G or 5G) and non-3GPP (including WiMAX or WiFi wireless means) networks depending on the proximity of the two devices, which needs to communicate. In another aspect, the proposed system and method for network traffic slicing uses network which can be implemented as one of the different types of networks, such as intranet, local area network (LAN), wide area network (WAN), the internet, and the like. The network may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Also, the network can include any new technology that comes in future for communication. Further the network may include a variety of network devices, including routers, bridges, servers, computing devices, storage devices, and the like.

In an aspect, the system and method can configured at a centralized network traffic controller or network device, which can be one or more combinations of a home gateway, a network gateway device, routers, switches, servers etc. that can decide how data packets can be treated and controls the flow or communication between IoT devices (for e.g. static or mobile communicable devices) based on different attributes.

In an exemplary aspect, using the system and method of present disclosure employing traffic slicing, a limited number of connections can be used for connecting maximum number of devices, while minimizing the exposure of communication to outer world and minimizing the cost of communication. In an typical implementation, the present invention enables a home/office, having IoT devices that needs to communicate with each other and with a user device located remotely from the home/office, which could have required several connections, to be managed by a single connection between with the user by a home gateway configured with system and method of present disclosure. The system of present disclosure can decide whether to use the 3GPP or non-3GPP network or any other alternative network to connect the two devices based on the distance of the two devices or based on network on which the device is currently available. The two devices can be any IoT devices which can be static and/or mobile device.

In an exemplary aspect, the present disclosure provides system and method for network traffic slicing based on the determination weather the two device, for example a static device and a mobile device, are falling within a house, or are connected directly through a single network device, or are falling in the same geographical boundary, and or are belonging to different geographies. The system and method can accordingly assign a 3GPP or non-3GPP network for communication between the two devices (mobile device and the static devices).

In a further exemplary aspect, the system and method for network traffic slicing for next generation networks can allocate network or distribute traffic among different networks, for example 3GPP network or non-3GPP network is selected based on the network under which two devices are available and if the device is registered at the gateway.

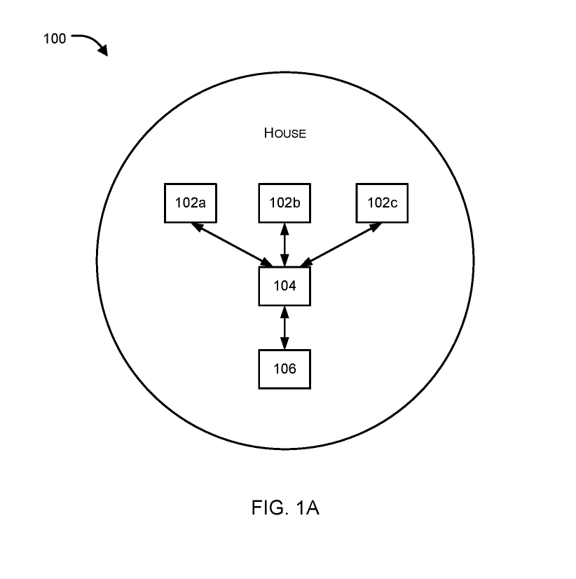

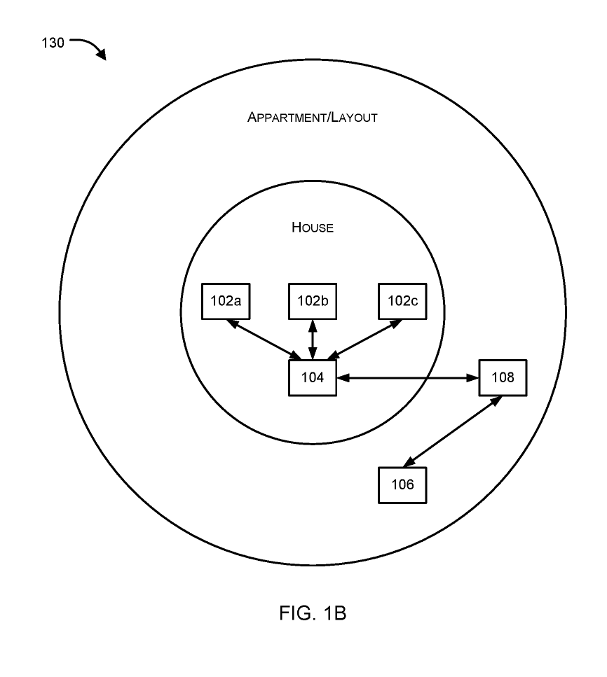

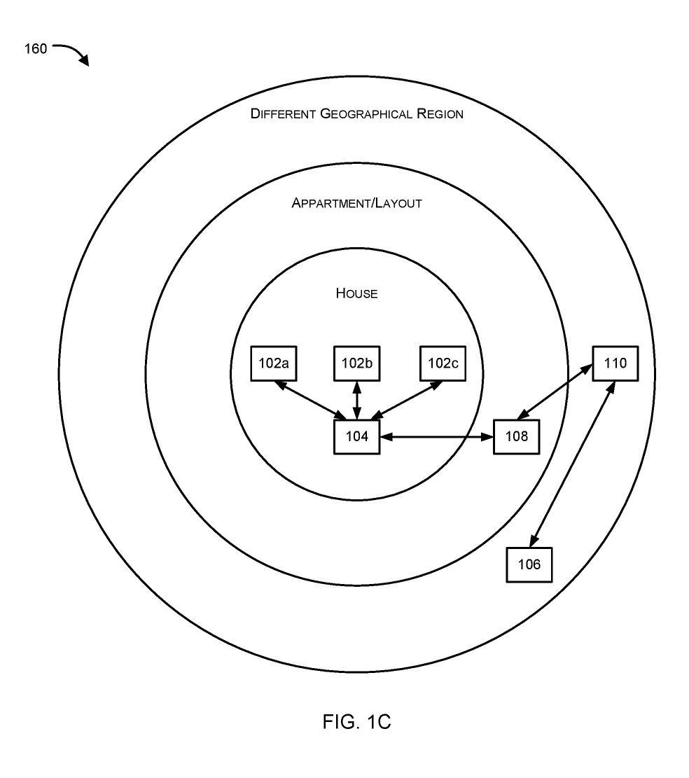

FIG. 1A illustrates exemplary communication between static devices and a mobile device present within same house in accordance with an embodiment of the present disclosure. As shown in diagram 100, a typical house/office may have plurality of IoT devices, such as D1 102a, D2 102b and D3 102c, collectively and interchangeably referred as IoT devices 102, that can communicate with mobile device 106 via non-3GPP network using network device 104 configured in accordance with an embodiment of the present disclosure, within the house. It may be understood that the IoT devices 102, the network device 104, and/or the mobile device 106 can include a variety of computing systems, such as a laptop computer, a desktop computer, a notebook, a workstation, a mainframe computer, a server, a network server, and the like. Examples of the IoT devices 102, the network device 104, and/or the mobile device 106 may further include, but are not limited to, a portable computer, a personal digital assistant, a handheld device, and a wearable device.

IoT devices 102 can be either static device or a mobile device present within the same house that can be capable of receiving information from other IoT devices, for example sensors, actuators, etc., and transmitting information over a non-3GPP wireless interface of network device 104 (can be a WiFi router). The non-3GPP wireless interface of network device 104 can be of small capacity that can cover area of any house or building and can be fixed as unit at a particular place in the house or any building. The network device 104 can receive information from devices 102 and can relay the information to mobile device 106 (can be any mobile device such as mobile phone, laptop, tab, etc.) and enable communication among the devices 102a-c. The network device 104 can directly send the information to mobile device 106 via a non-3GPP network and can receive information coming from devices 102.

In an exemplary embodiment, all the devices 102a-c present inside the house can be connected to a non-3GPP interface of the network device 104 that can be at a fixed location inside the house. All the information received from device 102 can be sent to the registered mobile device 106 of the house owner from network device 104. The data can be sent to mobile device 106 directly using non-3GPP network when the mobile device 106 happens to be inside the house. Though embodiments of the present disclosure have been described with reference to mobile device, any other user device, such as tablet, PC, laptop, PDA etc can be used.

FIG. 1B illustrates exemplary communication between static devices and a mobile device located within same geographical area using a network device in accordance with an embodiment of the present disclosure. The apartment or layout (consisting of in house area) 130 as shown in FIG. 1B, can includes devices 102,that can send data via first network device 104 to another network device 108 (the device 104 can communicate with device 108 using IP cables too), in case the mobile device 106 is out of range from first network device 104. In an exemplary implementation, a non-3GPP wireless interface of the network device 108 (can be a WiMAX router or switch) covering a much larger area can transfer the data/information received from the first network device 104 to mobile device 106. However, network device 108 can send and receive information via non-3GPP network when mobile device 106 happens to be within range, or else sends information via 3GPP network when mobile device 106 happens to be out of range.

In an exemplary embodiment, all devices located within small geographical locations like apartments or any layouts or locality can communicate using a non-3GPP interface of the network device 108.

In case devices 102 need to communicate to mobile device 106, all the information from devices 102 can be sent to network device 104 that can further check the whether mobile device 106 falls in the proximity of the network device 104 or not. If the mobile device 106 fall within the range of network device 104, the network device 104 can enable the communication between the device 102 and mobile device 106 through non-3GPP interface, else can forward the forward connection request to another network device 108 which can check if the connection between the device 102 and the mobile device 106 can be established using non-3GPP interface. Now network device 108 checks the location of mobile device 106, if the mobile device 106 falls within its range, then network device 108 sends the information or data to mobile device 106 using non-3GPP network. In case mobile device 106 happens to be out of range, the network device 108 can send the data to mobile device 106 via 3GPP network.

FIG. 1C illustrates exemplary communication between static devices and mobile device belonging to two different geographical region through a network device configured in accordance with an embodiment of the present disclosure. Communication, as shown in diagram 160,can be enabled by the network device, between devices present within the house, within the layout or locality, and devices present at a different geographical region (out of range for non-3GPP communication network) using a suitable communication mode.

In an exemplary embodiment, all the information or data from devices 102 can be sent to network device 104. The network device 104 checks whether the mobile device 106 is falling with-in its range or out of its range and the network device 104 on determination that the mobile device 106 is out of its range can send the data to a non-3GPP wireless network interface of network device 108 via non-3GPP network. Network device 108 on receiving data to be transmitted to mobile device 106, checks for mobile device 106 to determine were the mobile device 106 is falling with-in its range or out of its range and accordingly decides and sends the information or data via 3GPP network 110 to mobile device 106, as it determines that the mobile device 106 is out of range area or different geographical region.

Though the embodiment have been described reference to data being send from device 102 to mobile device 106, one may appreciate that the data/command can be sent from the mobile device 106 to devices 102.

It is also to be appreciated that, any communicating device (static or mobile), say the device 102 or the mobile device 106, should be registered with network devices to allow direct communication in non 3GPP mode. Only when the communicating device is registered with the network devices, the communicating device can directly communicate in non 3GPP mode, else, even if the communicating device is in same geographical location and is not registered with the network devices, they have to communicate using 3GPP mode only.

In an embodiment, the present invention enables any communicating device (static or mobile), when enters the range of a network device, to get registered to network device. One may appreciate that the process of registration can be automatic or manual). For example, A visitor device has come home, whose mobile is not registered with the network device. In that case non-3GPP cannot be used. Only 3GPP communication is possible. The visitor mobile if registers with the network device, then it can use non-3GPP network. Thus, the present invention enables the visitor device to get registered to the network device to use non-3GPP network without any obstacle.

As one may appreciate, the device 102 and mobile device 106 can both be mobile devices and appropriate mode of communication can be selected by depending on their location and distance with each other.

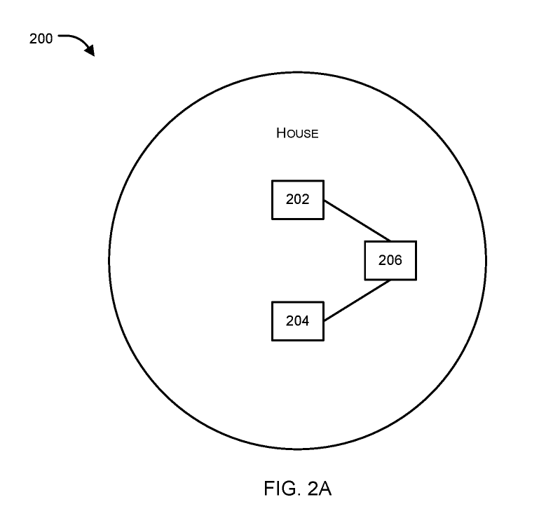

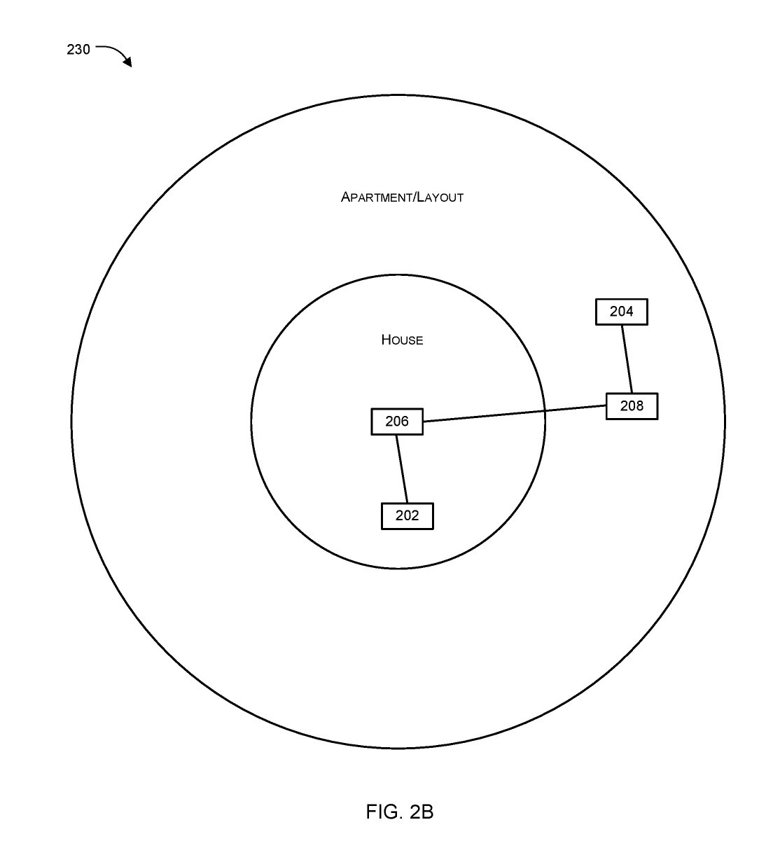

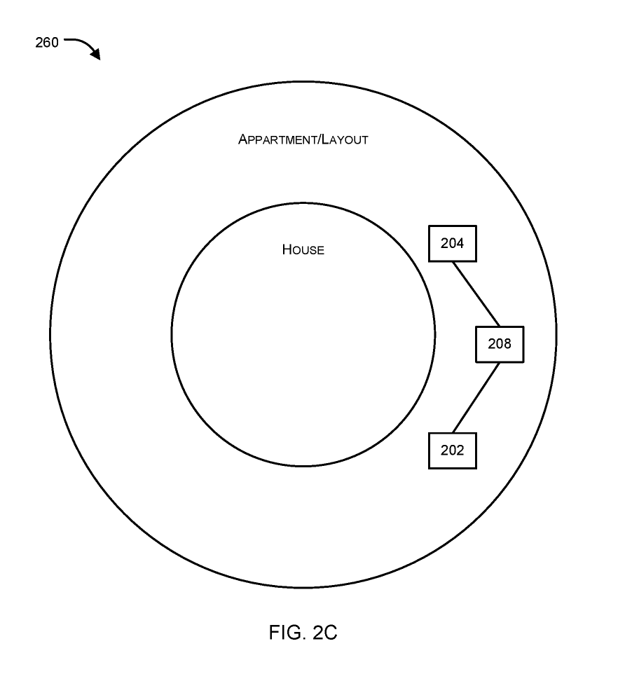

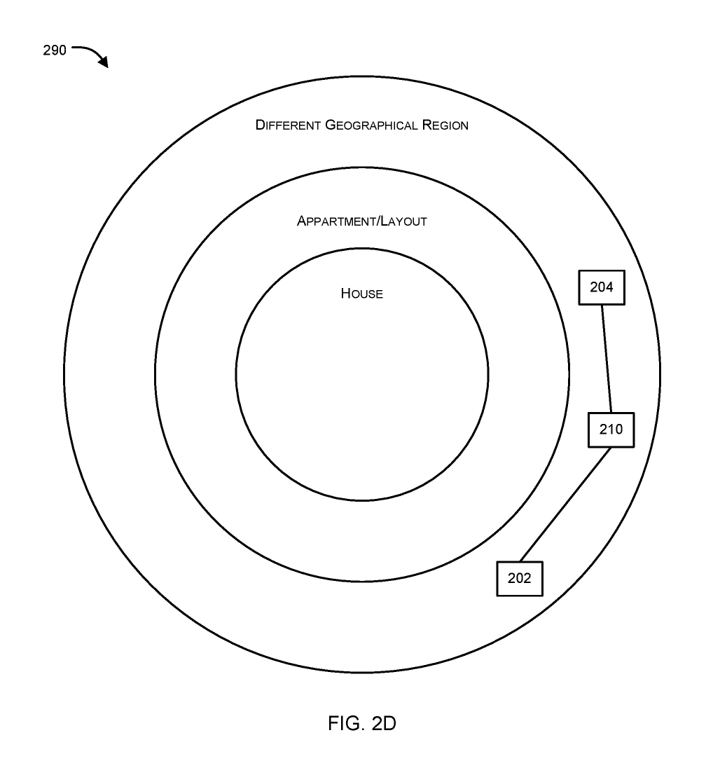

FIG. 2A illustrates exemplary communication between two mobile devices communicating with each other in accordance with an embodiment of the present disclosure. As shown in FIG. 2A, a communication between the two devices, such as mobile device 202 and mobile device 204 are in the same house, can be enable by the network device 206 over a non-3GPP interface.

In an exemplary embodiment, mobile device 202 can communicate with another mobile device 204 using a non-3GPP network as decided and assigned by the network device 206 (can be a small range WiFi router) that analyzes the range of communication lying in the close proximity or within the house.

FIG. 2B illustrates exemplary communication between two mobile devices located within the same geography in accordance with an embodiment of the present disclosure. As shown in diagram 230, the mobile device 202 resides within the house and mobile device 204 within the locality or layout but outside the house. The mobile device 202 can first establish the communication with network device 206 being in proximity of mobile devices 202 using non-3GPP network. Further, the network device 206 can connect to another network device 208 (wirelessly or by using IP cables) covering a larger area for wireless communication (can be a WiMAX network) within the same geography (like, apartment, layout, school/office/university campus, town, city, state, etc.). The network device 208 can search for mobile device 204 in its proximity or range, and on determination that the mobile device 204 is within its range, the network device 208 can establish the communication using a non-3GPP network as analyzed, and sends the information to mobile device 204, initiated or sent by mobile device 202.

FIG. 2C illustrates exemplary communication between two mobile devices within the same geographical location in accordance with an embodiment of the present disclosure. As shown in diagram 260 the mobile device 202 and the mobile device 204 are within the same geographical location like apartment or layout. In this exemplary communication the mobile device 202 and the mobile device 204 can communicate directly using network device 208 in non 3GPP mode.

FIG. 2D illustrates exemplary communication between two mobile devices belonging to two different geographies in accordance with an embodiment of the present disclosure. As shown in diagram 290 mobile devices 202 and mobile device 204 belongs to two different geographical regions or area. However the communication between the two mobile devices 202 and 204 can be established via a 3GPP network 210 as diagnosed and suggested by the main network device or server.

In an exemplary embodiment, the centralized network device (can be a single or combination of network devices) or any server responsible for diagnosing, evaluating the type of connection or network needed for communication between number of different devices either static or mobile, and location based communication. Thus based on the analysis of centralized network device, communication can be either established via a non-3GPP network (for smaller or larger range) or via a 3GPP network.

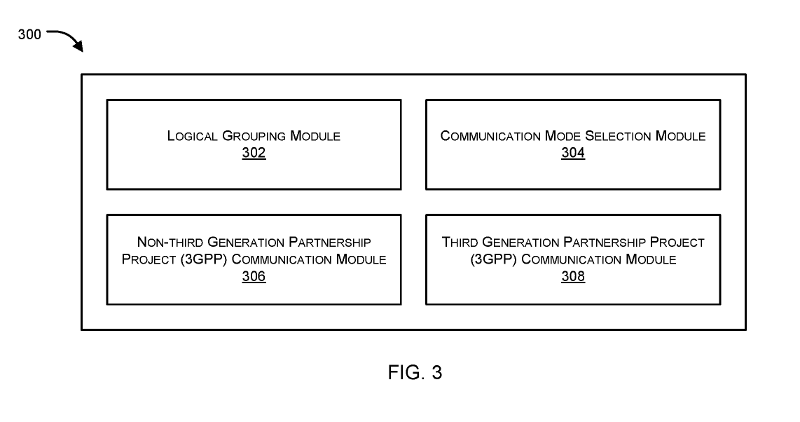

FIG. 3 illustrates functional modules of network traffic slicing system in accordance with an embodiment of the present disclosure. The system includes a logical grouping module 302 configured to dynamically group connected devices into plurality of logical groups based on different parameters/attributes, and a communication mode selection module 304 configured to determine the location of two devices, and their association with a particular group out of the plurality of logical groups and determines a mode of communication based on geographical location of two devices communicating with each other.

In an exemplary implementation, the mode of communication can be non 3-GPP mode of communicate if the two devices are associated with a logical group of devices that are places within the same building, or logical group of devices that are placed within the same geographical region. In an exemplary implementation, the mode of communication can be 3-GPP mode of communication if the two devices are associated with a logical group of devices that are located at wider distance or based on the network under which two devices are available and if the device is registered at the gateway.

In an embodiment, the system further includes a non-3GPP communication module 306 configured to use, non-3GPP mode of communication when two devices are in close proximity, and a 3GPP communication module 308 configured to use, 3GPP mode of communication when two devices are at wider distance.

It is to be appreciated that, any communicating device (static or mobile), should be registered with network devices to allow direct communication in non 3GPP mode. Only when the communicating device is registered with the network devices, the communicating device can directly communicate in non 3GPP mode, else, even if the communicating device is in same geographical location and is not registered with the network devices, they have to communicate using 3GPP mode only.

In an embodiment, the present invention enables any communicating device (static or mobile), when enters the range of a network device, to get registered to network device. One may appreciate that the process of registration can be automatic or manual). For example, a visitor device has come home, whose mobile is not registered with the network device. In that case non-3GPP cannot be used. Only 3GPP communication is possible. The visitor mobile if registers with the network device, then it can use non-3GPP network. Thus, the present invention enables the visitor device to get registered to the network device to use non-3GPP network without any obstacle.

In an embodiment, the different parameters/attributes can include any or combination of location of device, type of device, network of communication, and expected data size

In an exemplary embodiment, the system can logically group the devices communicating with each other based on geographical location of devices in communication and determine distance between the devices. In detail the system and method introduces hierarchy in communication by dividing the area into small geographical locations or can say regions such as within the house, within the geography (same apartment, layout, locality, town, city, etc.), and from different geographies (different towns, cities, states, territories, countries, etc.). All the devices in a single geographical location can communicate independently using non-3GPP and 3GPP networks. In case when communication takes place between devices from two different geographical location, then only 3GPP network can be used, else all the communication within the geographical location can be done using non-3GPP network. Thus network traffic can be sliced into different levels based on the geographical location of the two communicating devices.

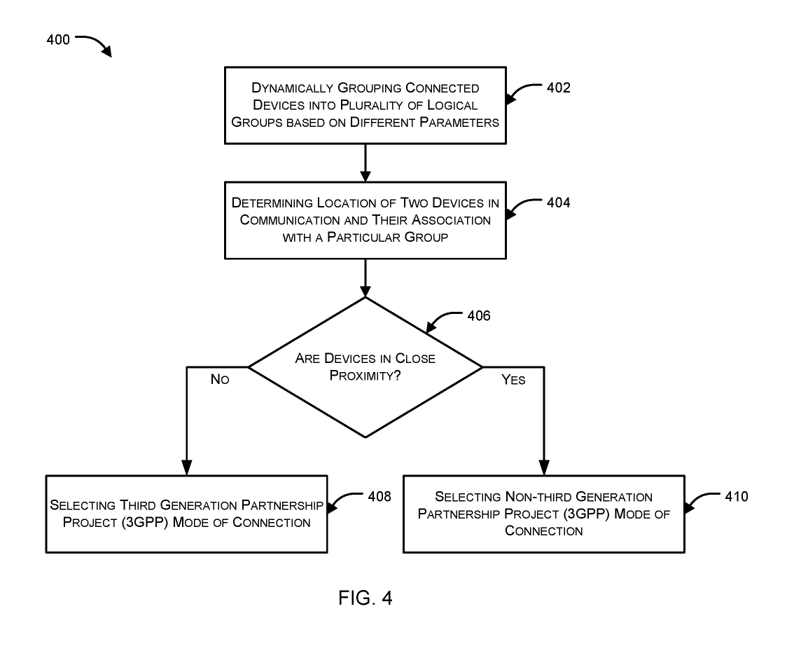

FIG. 4 illustrates a flow diagram for network traffic slicing method in accordance with an embodiment of the present disclosure.

A method for network traffic slicing including steps of dynamically grouping connected devices into plurality of logical groups based on different parameters/attributes as shown at step 402, determining location of two devices in communication and their association with a particular group as shown at step 404, checking if the two devices are in close proximity as shown at step 406, selecting a non-3GPP (3rd generation partnership project) mode of communication if the two devices are registered and are in close proximity for enabling communication between the two devices as shown at step 410, and/or selecting a 3GPP (3rd generation partnership project) mode of communication if the two devices are not registered and/or are not in close proximity, for enabling communication between the two device as shown at step 408.

It is to be appreciated that, any communicating device (static or mobile), should be registered with network devices to allow direct communication in non 3GPP mode. Only when the communicating device is registered with the network devices, the communicating device can directly communicate in non 3GPP mode, else, even if the communicating device is in same geographical location and is not registered with the network devices, they have to communicate using 3GPP mode only.

In an embodiment, the present invention enables any communicating device (static or mobile), when enters the range of a network device, to get registered to network device. One may appreciate that the process of registration can be automatic or manual). For example, a visitor device has come home, whose mobile device is not registered with the network device. In that case non-3GPP cannot be used. Only 3GPP communication is possible. The visitor mobile if registers with the network device, then it can use non-3GPP network. Thus, the present invention enables the visitor device to get registered to the network device to use non-3GPP network without any obstacle.

As one may appreciate, a threshold for determining the close proximity can be preconfigured, and if the distance or proximity of the two devices are more than that threshold, the communication between the two devices can be enabled through the 3GPP network, else through the non-3GPP network.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### ADVANTAGES OF THE INVENTION

The present disclosure provides a system and method for network traffic slicing for next generation communication networks.

The present disclosure provides a system and method for network traffic slicing that can reduce traffic density and network congestion from next generation communication networks.

1. A system for network traffic slicing, the system comprising:
a logical grouping module configured to dynamically group connected devices into plurality of logical groups based on different attributes, said attributes being any or a combination of location of device, type of device, available alternatives of communication and expected data size; and
a communication mode selection module configured to
determine locations of two devices that need to communicated;
determine association of the two devices with a particular group out of the plurality of logical groups; and
determine a mode of communication based on any or combination of the locations of two devices, and the association of the two devices with the particular group, said mode of communication being selected from non-3GPP mode of communication and 3GPP mode of communication, wherein the non-3GPP mode of communication is selected when the two devices are in close proximity, and wherein the 3GPP mode of communication is used when the two devices are at wider distance.

2-4. (canceled)

5. The system of claim 1, wherein the location of the two devices is determined using any or combination of GPS position discovery, cellular tower based location discovery, and connection of the two with a particular network device.

6. A method for network traffic slicing, the method comprising steps of:
dynamically grouping connected devices into plurality of logical groups based on different attributes; and
determining, for two devices that need to communicate, distance between the two devices and association of the two devices with a particular group out of the plurality of logical groups; and
determining a mode of communication based on any or combination of the location of two devices and the association of the two device with the particular group.

7. The method of claim 6, wherein the method comprises steps of enabling non-3GPP mode of communication when the two devices are in close proximity.

8. The method of claim 6, wherein the method further comprises steps of enabling 3GPP mode of communication when the two devices are at wider distance.

9. The method of claim 6, wherein the different attributes are any or a combination of location of device, type of device, network of communication, and expected data size.

10. The method of claim 6, wherein the location of the two devices is determined using any or combination of GPS position discovery, cellular tower based location discovery and connection of the two with a particular network device.
